(19) United States
(12) Patent Application Publication
(10) Pub. No.: US 2003/0007042 A1
(43) Pub. Date: Jan. 9, 2003

(54) Method for bonding inkjet printer cartridge elements

(76) Inventors: Jhih-Ping Lu, Hsinchu (TW); Charles C. Chang, Hsinchu (TW); Su-Jung Su, Hsinchu (TW); Sune-Chuan Lin, Hsinchu (TW); Shyh-Haur Su, Hsinchu (TW)

Correspondence Address: BIRCH STEWART KOLASCH & BIRCH, PO BOX 747, FALLS CHURCH, VA, 22040-0747, US

(21) Appl. No.: 09/956,962

(22) Filed: Sep. 21, 2001

(30) Foreign Application Priority Data
Jul. 3, 2001 (TW) 90116206

(51) Int. Cl. B41J 2/175

(52) U.S. Cl. 347/86

(57) ABSTRACT

A method for bonding inkjet printer cartridge elements utilizes adhesive film to bond an inkjet cartridge element to an inkjet printer cartridge body. The adhesive film is preformed to a desired shape and formed with selected openings to match with troughs located on the ink cartridge element bonding spot of the inkjet printer cartridge body. The adhesive film is placed on the bonding spot between the inkjet cartridge element and the inkjet printer cartridge body, and pressure or heat is then applied to bond the inkjet cartridge element, adhesive film and inkjet printer cartridge body tightly and securely.

### FIELD OF THE INVENTION

The present invention relates to a method for manufacturing inkjet printer cartridges, and particularly to a method for accurately bonding ink cartridge elements to an inkjet printer cartridge body.

### BACKGROUND OF THE INVENTION

Utilizing adhesive to bond two different elements together is a commonly used bonding method and has been widely adopted in general or special manufacturing techniques. In manufacturing inkjet print cartridges, adhesive bonding is an indispensable procedure in the manufacturing processes. Inkjet printer cartridges are essential devices in the normal inkjet printer operation. An inkjet printer cartridge generally consists of an inkjet printer cartridge body and some other ink cartridge elements such as inkjet print head chip, air vent mask, etc. The inkjet printer cartridge body contains ink, which may be emitted through an ejecting aperture on the inkjet print head chip to form ink dots on paper. The inkjet printer cartridge body usually has an air vent and an air vent trough to balance the interior pressure. The air vent trough is covered by the air vent mask. Conventionally, the ink cartridge elements are bonded to the inkjet printer cartridge by adhesive. Commonly used inkjet printer cartridges on the market usually require at least two to five different adhesives for the applications of bonding, sealing, back pressure control, conduction line protection, etc. Hence, manufacturing processes related to adhesives have a great impact on the product quality and costs. Taking the example of bonding the inkjet print head chip to the inkjet printer cartridge body, because the two elements are made of different materials, they cannot be bonded by integral forming or hypersonic welding. They have to be bonded by adhesive. Conventional adhesive bonding methods include utilizing adhesive point dispensing machines to apply adhesive such as Epoxy by pressure through a dispensing needle. The design of the dispensing route for the adhesive should match the structure of the bonding area on the inkjet printer cartridge where the ink cartridge elements are to be mounted. The adhesive dispensing needle may be moved to form different linear or curved lines under program control to dispense adhesive. However, this method has drawbacks. For instance, the adhesive dispensing rate and evenness depend on many factors such as adhesive properties, dispensing pressure, temperature, needle moving speed and position, etc. It is a great challenge to control and balance all of these factors for mass production. There is also the disadvantage that when the adhesive is not distributed or filled properly, air bubbles become mixed in the adhesive and result in void spots on the adhesive coating areas and leaking of the ink after the adhesive is dried. Furthermore, dispensing adhesive by points is too slow. The flow of adhesive fluid often results in poor dispensing accuracy. The downstream heating and curing processes for the adhesives (such as Epoxy) take a relatively long time, resulting in even lower production efficiency.

### SUMMARY OF THE INVENTION

The primary object of the invention is to resolve the aforesaid disadvantages and to provide a more reliable method for bonding inkjet printer cartridge elements that is not negatively effected by external factors such as adhesive quality, adhesive dispensing pressure, temperature, and moving speed of the adhesive dispensing needle

Another object of the invention is to provide evenly distributed adhesive coating without thickness variations at different adhesive dispensing times.

A further object of the invention is to increase adhesive application accuracy without creating adhesive positioning problems due to adhesive fluid flow and dispersion.

Yet another object of the invention is to increase the adhesive coating and curing speed to increase production efficiency and reduce production time and cost.

In order to achieve the foregoing objects, the method of the invention utilizes an adhesive film to bond an ink cartridge element to an inkjet printer cartridge body to replace conventional adhesive point dispensing methods. The adhesive film is preformed to a selected shape with desired openings. The openings are formed to match the troughs of the ink cartridge element bonding area located on the inkjet printer cartridge body. The troughs may consist of a single trough or a plurality of troughs. The number of openings may be one or many. In the preferred embodiments of the invention, the adhesive film is formed with a contour the same as or proximate to the ink cartridge element, and the opening on the adhesive film has a shape and size the same as or proximate to the mating trough on the inkjet printer cartridge body. The adhesive film is located between the inkjet printer cartridge body and the ink cartridge element in order to adhere the two to each other. Bonding between the adhesive film, the inkjet printer cartridge body and the ink cartridge element is accomplished by pressure or hot pressing. In one preferred embodiment of the invention robotic arms are used to take the adhesive film and place it on the bonding location of the inkjet printer cartridge body where the ink cartridge element is to be laid. The ink cartridge element is then placed on the adhesive film and pressure or heat is applied to bond the ink cartridge element, adhesive film, and inkjet printer cartridge body tightly and securely.

The bonding method of the invention may be adapted to bonding processes for inkjet print head chips, air vent masks, or other similar ink cartridge elements. The adhesive film has the advantages of even thickness, faster adhesive applying speed. accurate positioning and faster bonding, and can effectively overcome the disadvantages of conventional bonding methods that apply liquid adhesive by point dispensing.

The foregoing, as well as additional objects, features and advantages of the invention will be more readily apparent from the following detailed description, which proceeds with reference to the accompanying drawings. The drawings are for reference and illustrative purpose only, and thus are not intended to limit the scope of the invention.

### BRIEF DESCRIPTION OF THE DRAWINGS

FIG. 1 is a schematic view of a first embodiment of the invention, for bonding an inkjet print head chip to a chip trough of an inkjet printer cartridge body.

FIGS. 2A-2C are schematic views of forming a strip of adhesive film.

FIG. 3 is a schematic view of a second embodiment of the invention, for bonding an air vent mask to an air vent trough of an inkjet printer cartridge body.

### DESCRIPTION OF THE PREFERRED EMBODIMENTS

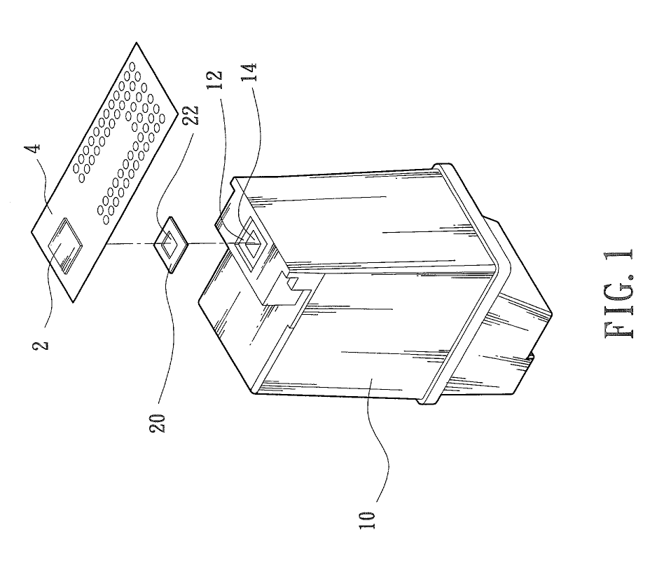

The invention aims to provide a method for quickly and accurately bonding inkjet printer cartridge elements to an inkjet printer cartridge body. FIG. 1 illustrates a first embodiment of the invention for bonding an inkjet print head chip 2 to an inkjet printer cartridge body 10. The inkjet printer cartridge body 10 has a chip trough 12 for bonding the inkjet print head chip. The chip trough 12 has a shape and size matching the contour shape and size of the inkjet print head chip 2. The inkjet print head chip 2 may be formed on a Flexible Printed Circuit (FPC) 4 by a Tape Automated Bonding (TAB) process.

The chip trough 12 has an outlet channel 14 formed on the bottom thereof to communicate fluidly with an ink container housed inside the inkjet printer cartridge body 10. Although only one ink outlet channel 14 is shown in the drawing, in actual practice, one or more ink outlet channels may be formed on the bottom of the chip trough 12 for different models of the inkjet printer cartridges. For instance, a color inkjet printer cartridge may have three chip troughs for supplying three different colors of ink.

During the bonding process, a strip of adhesive film 20 is formed in a selected shape with a selected opening 22, and the adhesive film 20 is then picked up by a robotic arm and placed rapidly and accurately on the chip trough 12. The chip trough 12 has a shape and size matching the shape and size of the contour of the inkjet print head chip 2. The opening 22 on the adhesive film 20 matches the ink outlet channel 14, preferably with the same or proximate shape and size, to prevent blocking the ink outlet channel 14.

The inkjet print head chip 2 is then precisely positioned on the adhesive film 20. Hot pressing, baking or pressure is then applied to bond the inkjet print head chip 2, adhesive film 20 and the inkjet printer cartridge body 10 tightly and securely to complete the process of bonding the inkjet print head chip 2.

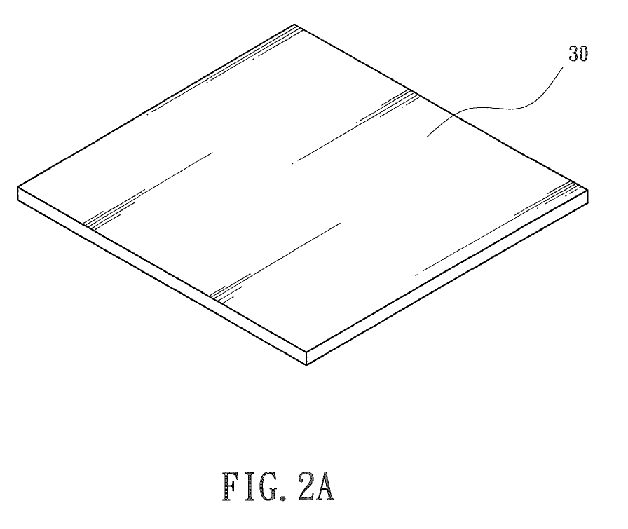

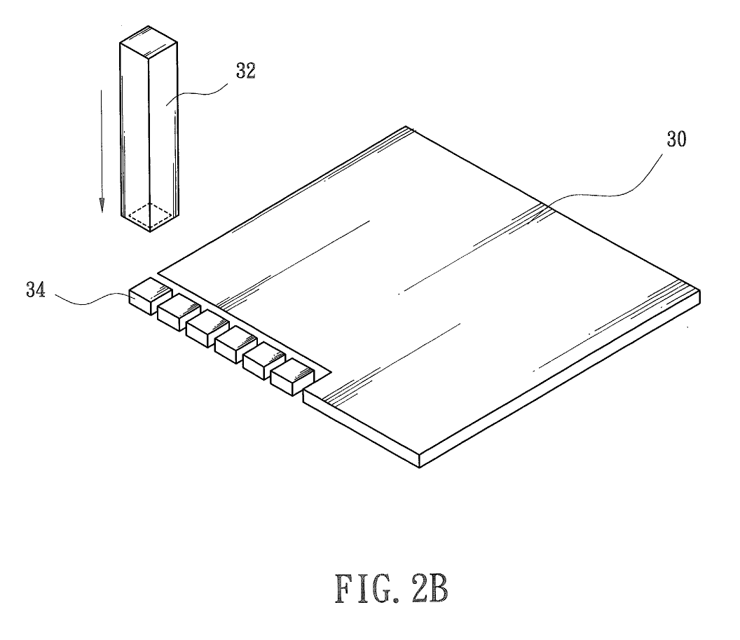

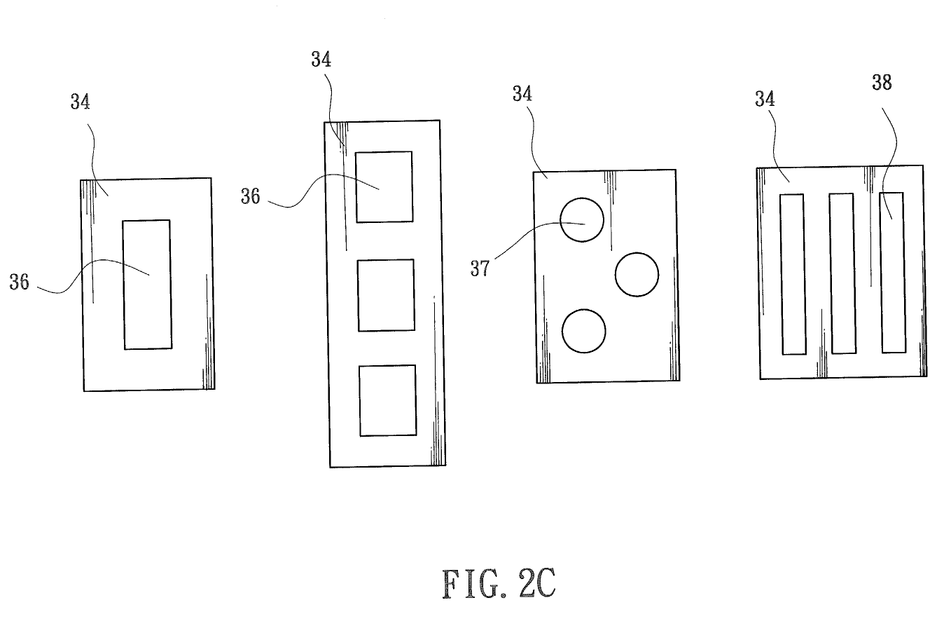

The bonding film may be made from hot-melt adhesives, hot-melt back adhesives, pressure sensitive adhesives, thermosetting adhesives (Epoxy), or any other suitable thermoplastic adhesive film. The forming method may be accomplished by punching as shown in FIGS. 2A-2C.

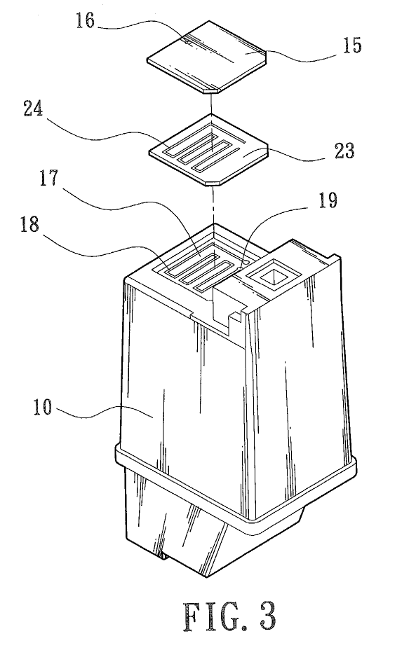

Referring to FIG. 2A, a large adhesive sheet 30 is first prepared. Referring to FIG. 2B, the adhesive sheet 30 is punched with a punch tool 32 to form strips of adhesive film 34 of selected shapes with openings 36, 37 or 38 of desired shapes, as shown in FIG. 2C. Of course, it is possible to punch and form the outer contour of the adhesive film 34 first, then punch and form the openings 36, 37 and 38. The number of openings may be one or many (as shown in FIG. 3), and they may be formed in various shapes such as rectangular 36, round 37, strip 38, or other irregular shapes.

There are many ways to form the adhesive film. What has been described above is only one of them, and it is not intended to limit the invention. For instance, the adhesive film may also be formed by spraying adhesives and curing. Moreover, the formed adhesive film may be covered by a release paper and be wrapped in rolls to facilitate production and packaging, or picked up by robotic arms for disposing directly onto the inkjet printer cartridges.

This bonding method for inkjet printer cartridge elements may also be adapted for bonding air vent masks. FIG. 3 shows another embodiment of the invention for bonding an air vent mask 15 to an inkjet printer cartridge body 10. The inkjet printer cartridge body 10 has a narrow and tortuous air vent trough 18 formed on an air vent mask bonding spot 17. At two ends of the trough, there are air vents 19 for communicating with the interior of the inkjet printer cartridge body 10. The air vent trough 18 and air vents 19 provide an air passage to an ink container located inside the inkjet printer cartridge body, such that when the back pressure in the inkjet printer cartridge body is too high, air will be supplied smoothly to balance the back pressure. The air vent mask 15 has an air inlet 16 mating to the middle section of the air vent trough 18 for supplying air. During the bonding process, a strip of adhesive film 23 is preformed with a suitable opening 24, and disposed on the air vent mask bonding spot 17. The air vent mask 15 is then placed on the adhesive film 23. Finally, hot pressing, baking or pressure is applied to bond the air vent mask 15 and adhesive film 23 to the inkjet printer cartridge body 10 tightly and securely. Similarly, the shape and size of the adhesive film 23, and the location, shape and size of the opening 24 may be formed by punching, or adhesive spraying and curing. The adhesive film 23 is preferably formed with the same or proximate shape and size of the air vent mask 15. The opening 24 corresponds to the air vent trough 18 and also has the same or proximate shape and size. so that after the bonding of the air vent mask is completed the air vent 18 will not be blocked and will function as desired.

In summary, the invention provides a method for bonding inkjet printer cartridge elements that has greater stability during the manufacturing process, can dispense adhesive evenly and accurately with greater efficiency, and can increase production yield and reduce costs.

While the preferred embodiments of the invention have been set forth for the purpose of disclosure, modifications of the disclosed embodiments of the invention as well as other embodiment thereof may occur to those skilled in the art. Accordingly, the appended claims are intended to cover all embodiments which do not depart from the spirit and scope of the invention.

What is claimed is:

1. A method for bonding inkjet print cartridge elements for bonding an ink cartridge element to an inkjet print cartridge body which has at least one trough located at a selected position mating the ink cartridge element, the method comprising the steps of:
preparing an adhesive film with at least one opening formed thereon corresponding to the position of the trough;
placing the adhesive film between the ink cartridge element and the inkjet print cartridge body; and
bonding securely the ink cartridge element and the adhesive film to the inkjet print cartridge body.

2. The method of claim 1, wherein the opening has a shape and size mating the trough for preventing the adhesive film from blocking the trough.

3. The method of claim 1, wherein the opening has a shape and a size same as the trough.

4. The method of claim 1, wherein the adhesive film is pre-formed with a contour proximate to the ink cartridge element.

5. The method of claim 1, wherein the ink cartridge element is an inkjet print head chip, and the trough is an ink outlet channel.

6. The method of claim 1, wherein the ink cartridge element is an air vent mask and the trough is an air vent trough.

7. The method of claim 1, wherein the adhesive film is a thermoplastic adhesive film.

8. The method of claim 1, wherein the adhesive film is a thermosetting adhesive film.

9. The method of claim 1, wherein the adhesive film is a pressure sensitive adhesive film.

10. The method of claim 1, wherein the adhesive film and the opening are formed by punching of punching machines.

11. The method of claim 1, wherein the adhesive film and the opening are formed by spraying adhesive and curing.

12. The method of claim 1, wherein the bonding of the ink cartridge element, the adhesive film and the inkjet print cartridge body is done by applying pressure.

13. The method of claim 1, wherein the bonding of the ink cartridge element, the adhesive film and the inkjet print cartridge body is done by heating and baking.

14. The method of claim 1, wherein the bonding of the ink cartridge element, the adhesive film and the inkjet print cartridge body is done by hot pressing.
